(19) United States
(12) Patent Application Publication
(10) Pub. No.: US 2003/0193476 A1
(43) Pub. Date: Oct. 16, 2003

(54) Structure of rechargeable wireless mouse

(76) Inventor: Ho-Lung Lu, Panchiao City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/119,683

(22) Filed: Apr. 11, 2002

(51) Int. Cl. G09G 5/08

(52) U.S. Cl. 345/163

(57) ABSTRACT

A rechargeable wireless mouse is constructed to include a mouse body, the mouse body having a power input plug, a position detector, and input means, for example, operation keys and/or a signal input wheel, and a circuit board mounted in the mouse body, the circuit board having a power converter circuit electrically coupled to the power input plug of the mouse body adapted to convert input AC power into stabilized DC power to charge a rechargeable battery thereof, and a control circuit electrically coupled to the position detector and the input means of the mouse body and adapted to control the operation of the wireless mouse and to transmit signal to the receiver unit of the computer.

### BACKGROUND OF THE INVENTION

1. Field of the Invention

The present invention relates to a wireless mouse and, more particularly, to a rechargeable wireless mouse, which is equipped with a rechargeable battery and an electric plug for receiving external AC power to charge the rechargeable battery.

2. Description of the Related Art

Computer input devices are numerous. A mouse is one of the most popularly used computer input devices. By means of moving mouse cursor and clicking mouse button, a mouse eliminates complicated keyboard input operation. Conventional mice commonly have a transmission cable for connection to the computer. However, the transmission cable limits the moving range of the mouse relative to the computer and, tends to be tangled with other objects on the table. In order to eliminate these drawbacks, wireless mice are developed. FIG. 1 illustrates the use of a wireless mouse system with a computer. As illustrated, the wireless mouse system comprises a transmitter unit 1a, namely, the wireless mouse, and a receiver unit 2a connected to the computer 4a through a transmission cable 3a. The transmitter unit 1a is controlled to transmit signal to the receiver unit 2a by radio wave or infrared ray. The receiver unit 2a converts the signal from the transmitter unit 1a into a computer readable signal, and then passes the signal to the computer 4a through the transmission cable 3a. The transmitter unit 1a has a set of battery cells 5a, which provides the transmitter unit 1a with the necessary working power. This structure of wireless mouse is functional. However, the wireless mouse cannot obtain the necessary working power from the computer 4a. When the power of the battery cells 5a is low, the battery cells 5a should be replaced. Further, used battery cells must be properly disposed of to prevent environmental pollution.

### SUMMARY OF THE INVENTION

The present invention has been accomplished under the circumstances in view. One object of the present invention is to provide a wireless mouse, which is equipped with a rechargeable battery that provides the necessary working power. Another object of the present invention is to provide a wireless mouse, which has a power input plug adapted to receive city AC power for charging the rechargeable battery stored therein. To achieve these and other objects of the present invention, the rechargeable wireless mouse is comprised of a mouse body and a circuit board. The mouse body comprises a power input plug, a position detector, and input means, for example, operation keys and/or signal input wheel. The circuit board is mounted in the mouse body, comprising a power converter circuit electrically coupled to the power input plug of the mouse body adapted to convert input AC power into stabilized DC power to charge a rechargeable battery thereof, and a control circuit electrically coupled to the position detector and the input means of the mouse body and adapted to control the operation of the wireless mouse and to transmit signal to the receiver unit of the computer.

### BRIEF DESCRIPTION OF THE DRAWINGS

FIG. 1 illustrates the arrangement of a wireless mouse system with a computer according to the prior art.

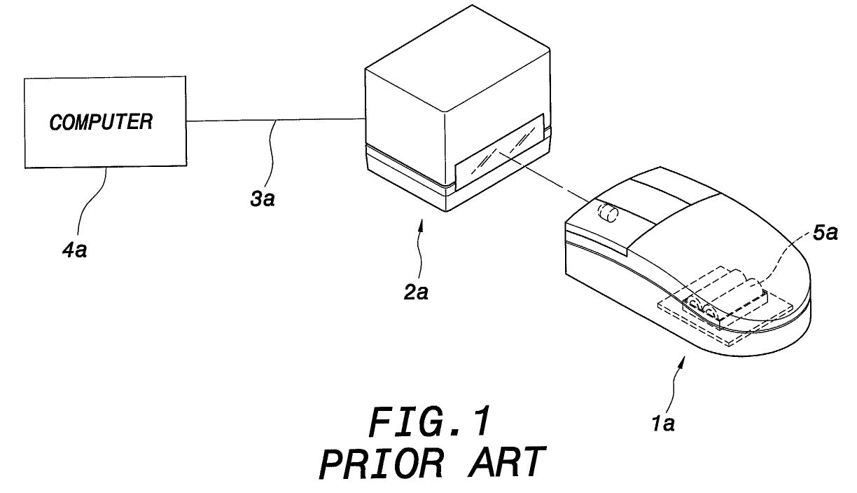

FIG. 2 is a rear elevation of a rechargeable wireless mouse according to the present invention.

FIG. 3 is a circuit block diagram of the present invention.

FIG. 4 is a circuit diagram of the power adapter according to the present invention.

FIG. 5 is a circuit diagram of an alternate form of the power adapter according to the present invention.

FIG. 6 is a circuit diagram of the control circuit according to the present invention.

FIG. 7 illustrates the relationship between the rechargeable wireless mouse and an electric outlet according to the present invention.

FIG. 8 is a bottom view of an alternate form of the rechargeable wireless mouse constructed according to the present invention.

FIG. 9 is a rear elevation of a rechargeable wireless mouse constructed according to a third embodiment of the present invention.

### DETAILED DESCRIPTION OF THE PREFERRED EMBODIMENT

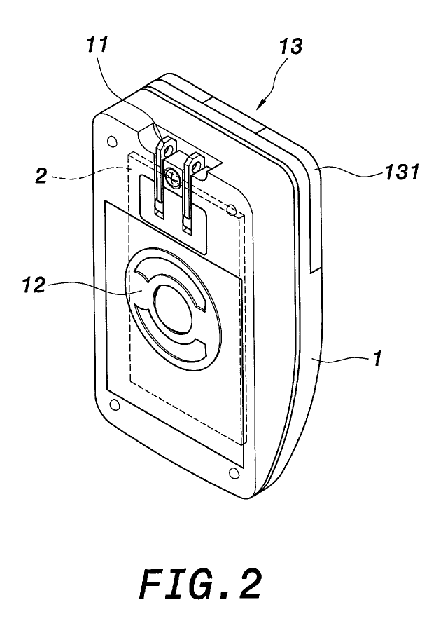

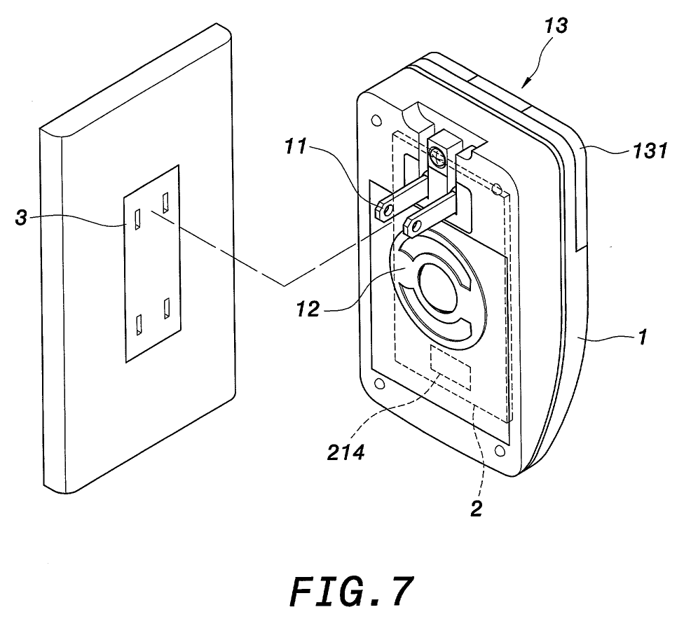

Referring to FIG. 2, a rechargeable wireless mouse is shown comprising a mouse body 1 and a circuit board 2. The mouse body 1 comprises a power input plug 11, a position detector 12, and input means 13. The power input plug 11 is provided at one side of the mouse body 1. According to this embodiment, the power input plug 11 is pivoted to the bottom side of the mouse body 1 and turned in and out of the mouse body 1 between the operative position (see FIG. 7) and the non-operative position (see FIG. 2). The input means 13 is comprised of, for example, a set of buttons 131 and/or a wheel(not shown). The position induction sensor 12 is of mechanical driven design. The circuit board 2 is mounted inside the mouse body 1, and electrically connected to the power input plug 11, the position detector 12, and the input means 13.

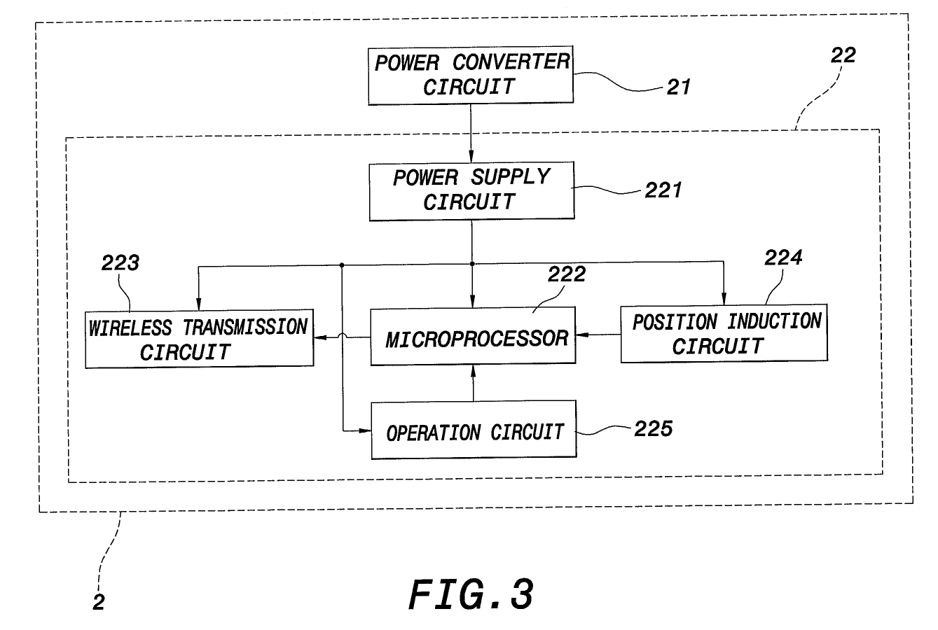

Referring to FIG. 3, the circuit board 2 comprises a power converter circuit 21 and a control circuit 22. The power converter circuit 21 is electrically coupled to the power input plug 11 of the mouse body 1, and adapted to convert city AC power into DC power for the control circuit 22. The control circuit 22 is adapted to control the operation of the wireless mouse and to transmit signal to the receiver unit of the computer, comprised of a power supply circuit 221, a micoprocessor 222, a wireless transmission circuit 223, a position induction circuit 224 and an operation circuit 225.

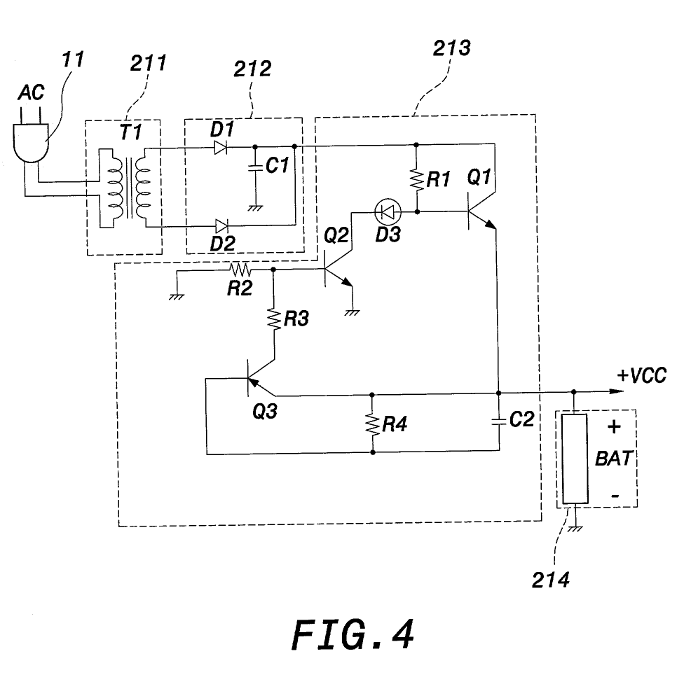

The power converter circuit 21 of the circuit board 20 may be variously embodied. FIG. 4 shows an example of the power converter circuit 21. According to this embodiment, the power converter circuit 21 is comprised of a transformer 211, a rectifier filter circuit 212, a voltage stabilizer circuit 213, and a rechargeable battery 214. The power input end of the transformer 211 is connected to the aforesaid power input plug 11 to receive external AC power. The rectifier filter circuit 212 is comprised of diodes D1 and D2 and a capacitor C1, and connected to the power output end of the transformer 211 to rectify inputted AC power into a ripple voltage. The voltage stabilizer circuit 213 is comprised of a diode D3, resistors R1˜R4, and transistors Q1˜Q2, and connected to the output end of the rectifier filter circuit 212 to convert the ripple voltage received from the rectifier filter circuit 212 into a stable DC voltage. The rechargeable battery 214 is connected to the output end of the voltage stabilizer circuit 213 and charged by the stabilized DC voltage from the voltage stabilizer circuit 213.

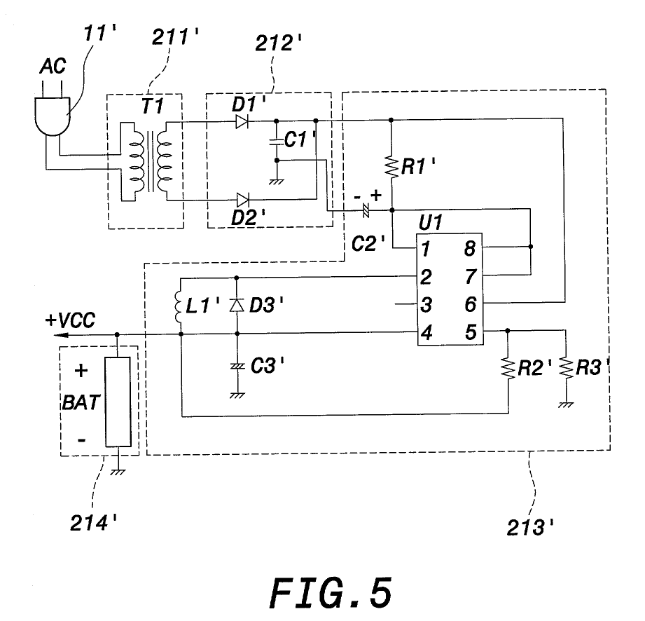

FIG. 5 shows an alternate form of the power converter circuit 21. According to this alternate form, the power converter circuit 21 is comprised of a transformer 211′, a rectifier filter circuit 212′, a voltage stabilizer circuit 213′, and a rechargeable battery 214′. The power input end of the transformer 211′ is connected to the power input plug 11′ to receive external input AC power. The rectifier filter circuit 212′ is comprised of diodes D1′ and D2′ and a capacitor C1′, and connected to the power output end of the transformer 211′ to rectify inputted AC power into a ripple voltage. The voltage stabilizer circuit 213′ is comprised of a control IC U1, resistors R1′˜R3′, capacitors C2′˜C3′, and an inductor L1′, and connected to the output end of the rectifier filter circuit 212′ to convert the ripple voltage received from the rectifier filter circuit 212′ into a stable DC voltage. The rechargeable battery 214′ is connected to the output end of the voltage stabilizer circuit 213′, and charged by the stabilized DC voltage from the voltage stabilizer circuit 213′. This alternate form uses the control IC U1 to provide a constant current output to charge the rechargeable battery 214′, preventing significant variation of output current from the voltage stabilizer circuit 213′ that may shortens the lifetime of the rechargeable battery 214′.

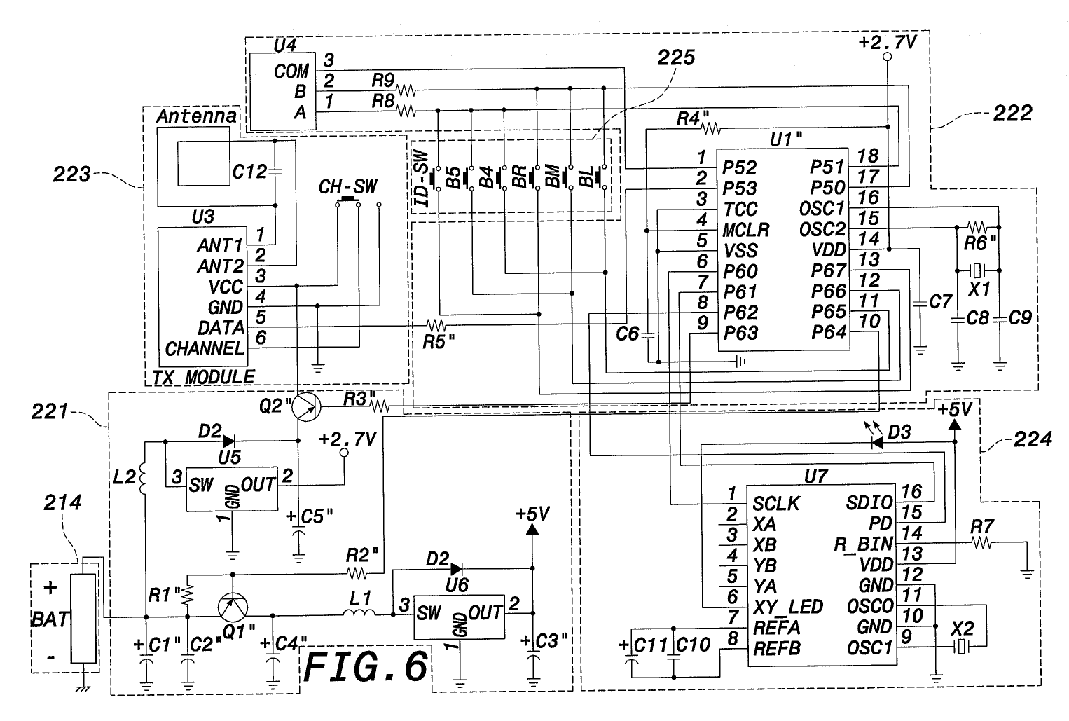

Referring to FIG. 6, the aforesaid power supply circuit 221 is comprised of resistors R1″˜R3″, capacitors C1″˜C5″, and transistors Q1″ and Q2″, and electrically connected to the microprocessor 222, the wireless transmission circuit 223, and the position induction circuit 224, and adapted to convert output voltage of the rechargeable battery 214 into a working voltage for the microprocessor 222, the wireless transmission circuit 223, and the position induction circuit 224. The position induction circuit 224 is comprised of an IC chip U7, capacitors C10 and C11, a resistor R7, and an oscillator X2, and adapted to detect direction and amount of movement of the mouse body 1 and to output a corresponding position displacement parameter. The microprocessor 222 is comprised of a CPU U1″, resistors R4″˜R6″ and R8˜R9, capacitors C6˜C9, and adapted to receive the position displacement parameter outputted from the position induction circuit 224, to receive signals sent from the operation circuit 225, and to output a signal corresponding to the detection result. The operation circuit 225 is comprised of operation keys ID-Sw, B₁₃ 5, B_4, B_R, B_M, B_L, and adapted to detect the action of the buttons 131 and to send a signal corresponding to the detected action to the microprocessor 222. The wireless transmission circuit 223 is comprised of a control IC U3, a capacitor C12, and an operation keys CH₁₃ SW, and adapted to transmit the output signal of the microprocessor 222 to the outside (external computer). Further, the wireless transmission circuit 223 can be a radio transmitting module or infrared transmitting module.

Regularly, the rechargeable battery 214 provides the necessary working voltage for the rechargeable wireless mouse. When power low, the user can directly plug the power input plug 11 into an electric outlet 3, enabling the rechargeable battery 214 to be charged to the saturated status. Because city AC power can easily be obtained, the rechargeable battery 214 of the rechargeable wireless mouse can quickly be charged when power low.

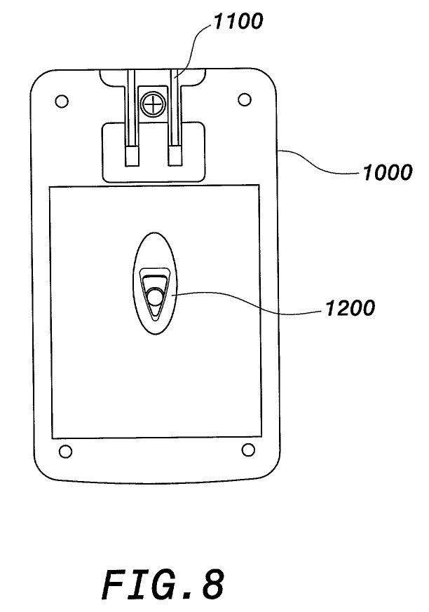

FIG. 8 shows a rechargeable wireless mouse according to a second embodiment of the present invention. The rechargeable wireless mouse of the second embodiment comprises a mouse body 1000, a plug input 1100 and a position detector 1200. According to this embodiment, the rechargeable wireless mouse has the same structure as the first embodiment except that the position detector 1200 is of optical induction design using an optical scanner to detect the direction and amount of displacement of the mouse body 1000.

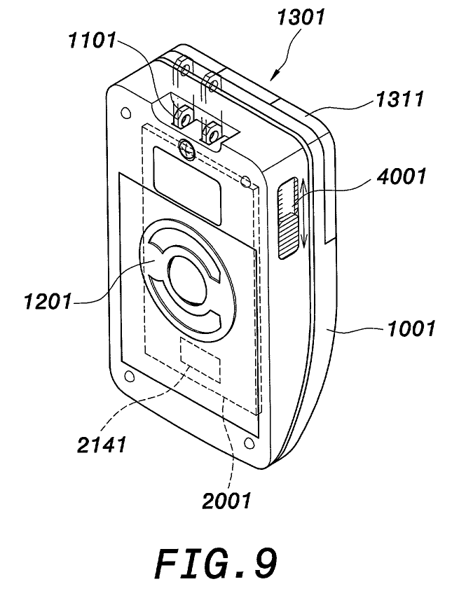

FIG. 9 shows a rechargeable wireless mouse according to a third embodiment of the present invention. The rechargeable wireless mouse of the third embodiment comprises a mouse body 1001, a plug input 1101, a position detector 1201, a slide switch 4001, input means 1301 that comprises a set of buttons 1311 or a wheel(not shown), and a rechargeable battery. According to this embodiment, the rechargeable wireless mouse has the same structure as the first embodiment except that the mouse body 1001 has a slide switch 4001 controlled to move the power input plug 1101 in and out of the mouse body 1001 between the operative position and the non-operative position.

A prototype of rechargeable wireless mouse has been constructed with the features of the annexed drawings of FIGS. 2˜9. The rechargeable wireless mouse functions smoothly to provide all of the features discussed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A rechargeable wireless mouse comprising:
a mouse body, said mouse body comprising a power input plug, a position detector, and input means; and
a circuit board mounted in said mouse body, said circuit board comprising a power converter circuit electrically coupled to said power input plug of said mouse body, and a control circuit electrically coupled to said position detector and said input means of said mouse body.

2. The rechargeable wireless mouse as claimed in claim 1, wherein said mouse body comprises a slide switch adapted to move said power input plug in and out of said mouse body.

3. The rechargeable wireless mouse as claimed in claim 1, wherein said power input plug is fixedly connected to one side of said mouse body.

4. The rechargeable wireless mouse as claimed in claim 1, wherein said power input plug is pivoted to said mouse body and can be turned in and out of said mouse body.

5. The rechargeable wireless mouse as claimed in claim 1, wherein said position detector is a mechanical position detector.

6. The rechargeable wireless mouse as claimed in claim 1, wherein said position detector is an optical position detector.

7. The rechargeable wireless mouse as claimed in claim 1, wherein said input means is comprised of at least one operation key.

8. The rechargeable wireless mouse as claimed in claim 1, wherein said input means is comprised of a wheel.

9. The rechargeable wireless mouse as claimed in claim 1, wherein said power converter circuit comprises:
a transformer, said transformer having a power input end connected to said power input plug of said mouse body and adapted to receive AC power, and a power output end;
a rectifier filter circuit adapted to rectify inputted AC power into a ripple voltage, said rectifier filter circuit having an input end connected to the power output end of said transformer and an output end;
a voltage stabilizer circuit adapted to convert the ripple voltage outputted from the output end of said rectifier filter circuit into a stable DC voltage, said voltage stabilizer circuit having an input end connected to the output end of said rectifier filter circuit and an output end; and
a rechargeable battery connected to the output end of said voltage stabilizer circuit for charging by the stabilized DC voltage from said voltage stabilizer circuit.

10. The rechargeable wireless mouse as claimed in claim 1, wherein said control circuit comprises:
a power supply circuit adapted to convert output voltage of said rechargeable battery into a working voltage;
a position induction circuit adapted to detect the direction and amount of movement of said mouse body and to output a corresponding position displacement parameter;
a microprocessor adapted to receive the position displacement parameter outputted by said position induction circuit, to detect the action of said input means, and to output signal corresponding to the action of said input means and the outputted position displacement parameter of said position induction circuit; and
a wireless transmission circuit adapted to transmit the output signal of said microprocessor to an external receiver means.

11. The rechargeable wireless mouse as claimed in claim 10, wherein said wireless transmission circuit is a radio transmitting module.

12. The rechargeable wireless mouse as claimed in claim 10, wherein said wireless transmission circuit is an infrared transmitting module.
